(19) United States
(12) Patent Application Publication
(10) Pub. No.: US 2006/0284150 A1
(43) Pub. Date: Dec. 21, 2006

(54) Magnetic electrical snake

(76) Inventors: Jerry J. Spadaro, Middletown, NJ (US); Louis Spadaro, Middletown, NJ (US)

Correspondence Address: Charles I. Brodsky, 2 Bucks Lane, Marlboro, NJ, 07746, US

(21) Appl. No.: 11/153,129

(22) Filed: Jun. 16, 2005

(51) Int. Cl. H02G 1/08

(52) U.S. Cl. 254/134.3 FT

(57) ABSTRACT

A first, or mouse magnet inserted on one side of a sheetrock wall or ceiling is provided with an aperture to receive a trailing pull-cord attached to an electrical wire to be snaked through, and is drawn between its entry opening and an exit opening in the wall or ceiling by moving a second, or mother magnet on the opposite side of the wall or ceiling via a handle provided thereon.

### CROSS-REFERENCE TO RELATED APPLICATIONS

NONE

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to the snaking of electrical wires, in general, and to the snaking of electrical wires behind insulated sheetrock walls and ceilings, in particular.

2. Description of the Related Art

As is well known, the snaking of electrical wires behind a sheetrock wall or ceiling in a residential home is a time consuming task. A metal snake is typically employed, inserted through a first opening in the wall or ceiling, and then fed through in hopes of exiting at a second opening. Once accomplished, the electrical wire is tied to one end of the snake, and then fed through by pulling on the other end. One of the problems, however, especially where the wall or ceiling is insulated, is that the metal snake frequently gets hung up in the insulation, or otherwise gets stuck. Because of the snake's being relatively sturdy and inflexible, repeated attempts are often necessary to dislodge it. Many are the occasions, however, when jiggling, pulling and pushing the snake does not succeed, and the snake has to be cut and left behind in the wall. A second, and sometimes other attempts, follows for the snaking to be accomplished.

### OBJECTS OF THE INVENTION

It is an object of the present invention, therefore, to provide a new and improved way to snake electrical wires behind sheetrock walls and ceilings.

It is an object of the invention, also, to provide a method of snaking electrical wires which is simple to accomplish, and which adds substantially no material costs for the operation beyond that which typically is associated with the stringing of metal electrical snakes from off a spool.

It is another object of the invention to provide not only a method of effectively accomplishing such snaking of electrical wires—behind insulated sheetrock walls or ceilings, or those which are not insulated as well—but to also provide apparatus for accomplishing this at a cost less than that which typifies the $50.00-$150.00 normally spent when purchasing the electrical snake spools.

### SUMMARY OF THE INVENTION

As will become clear from the following description, the method and apparatus of the present invention operates by utilization of a magnetic electrical snake. As will be described, the apparatus for snaking the electrical wire will be seen to include a first, or mouse magnet having an aperture, along with a trailing pull-cord having first and second ends, preferably of a nylon composition. A second, or mother magnet is provided, along with a length of the electrical wire to be snaked. In accordance with the invention, then, by coupling the pull-cord ends between the mouse magnet aperture and the length of electrical wire, moving the mother magnet along one side of the sheetrock wall or ceiling becomes effective to move the mouse magnet in a corresponding direction when inserted on an opposite side of the sheetrock wall or ceiling. Once the mouse magnet reaches the exit opening, it can be grasped, drawn through the exit opening along with the trailing cord and electrical wire, with the end of the pull-cord then being uncoupled from the mouse magnet freeing the wire. The cord can then be stored away or used again for snaking additional electrical wiring.

Testing has shown that the task can be simplified, further, by having the mouse magnet of substantially circular configuration—preferably of some ⅞ inch diameter and some 1/16 inch thickness. The aperture for the mouse magnet, in a preferred embodiment, is located at one of an upper and lower end of the disk, so as to be useful in snaking, for example, a wire down from the top of a sheetrock wall to the bottom, or from the bottom toward the top. Experience has shown, additionally, that in snaking upwardly, a good place to insert the mouse magnet is through an electrical outlet box hole in the wall, to allow for an upwards pulling of the trailing cord and connected electrical wire. To facilitate moving the mother magnet positioned on the opposite (i.e. outside) surface of the sheetrock wall or ceiling, a handle is provided for manual grasping and moving—and a handle which is movable in at least an upwards and downwards plane has been found to be especially attractive.

A method of snaking an electrical wire behind a sheetrock wall or ceiling using this apparatus may comprise the following steps:

a) providing a first entry opening and a second exit opening in the sheetrock wall or ceiling;

b) inserting the mouse magnet through the entry opening against an inside surface of the wall or ceiling;

c) coupling one end of the pull-cord to the aperture on the mouse magnet and a second end of the pull-cord to the electrical wire to be snaked;

d) placing the mother magnet against the sheetrock wall or ceiling on the opposite surface of the wall or ceiling, adjacent the entry opening and opposite the point where the mouse magnet is positioned;

e) manually moving the mother magnet along the surface toward the exit opening;

f) grasping the mouse magnet when it reaches the exit opening and drawing it, the trailing pull-cord and the electrical wire through; and

g) uncoupling the pull-cord from the mouse magnet's aperture.

To simply the operation, the trailing cord could simply be hooked to the mouse magnet aperture at the one end, and tied to the electrical wire to be snaked at the other end.

### BRIEF DESCRIPTION OF THE DRAWINGS

These and other features of the present invention will be more clearly understood from a consideration of the following description, taken in connection with the accompanying drawings, in which:

FIG. 1 is a side view of a sheetrock wall along with the apparatus of the invention, helpful in an understanding of the method of utilizing the magnetic electrical snake to extend an electrical wire behind a sheetrock wall;

FIG. 2 is a front view of the first, or mouse magnet of the invention; and

FIGS. 3a and 3b are side views of two types of mouse magnets that are especially useful in the snaking of electrical wires behind insulated sheetrock walls or ceilings.

### DETAILED DESCRIPTION OF THE INVENTION

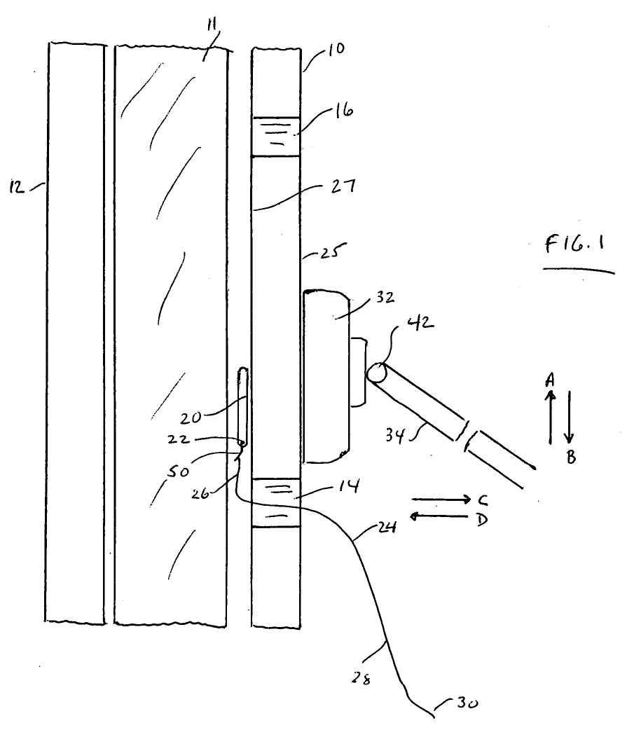

In FIG. 1, a sheetrock wall is shown at 10, 12, with the insulation between being shown at 11. An outlet box hole is shown at 14 cut within the wall 10, and a hole 16 is provided through which a snaked electrical wire is intended to exit.

The apparatus of the invention includes a first or mouse magnet 20 having an aperture 22 at its lower end (for the illustrated example of the invention where the snaked wire is to be fed upwardly, otherwise the aperture 22 could be positioned at the top of the mouse magnet 20 were the snaking to be in the opposite direction, that is, downwardly). A trailing pull-cord 24 is shown having first and second ends 26, 28 for snaking a length of electrical wire 30 upwardly toward the exit opening 16. A second, or mother magnet 32 is shown, preferably with a handle 34, which can be moved upwardly or downwardly in the direction of the arrows A, B if desired (or horizontally from left to right as with the arrows C, D depending upon the design of its pivot 42). In accordance with the invention, the two magnets 32, 20 are selected so that moving the mother magnet 32 along its illustrated side surface 25 of the sheetrock wall 10 is effective to move the mouse magnet 20 on its own side surface 27 of the sheetrock wall 10 in a corresponding direction. Once the handle 34 moves the mother magnet 32 to attract the mouse magnet 20 towards and into the exit opening 16, the mouse magnet 20 can be grasped, and drawn through the exit opening 16 along with the pull-cord 24 and the electrical wire 30.

So as to facilitate the movement of the mouse magnet along the inside surface 27 of the sheetrock wall 10, the mouse magnet is selected of a substantially circular disk configuration. A ⅞ inch diameter and 1/16 inch thickness have proved especially useful. Coupling the trailing pull-cord 24 to the aperture 22 on the mouse magnet 20 by a hook 50, as shown, has also proven attractive to simplify and hasten the snaking. Obviously, and as will be appreciated by a practicing electrician, the snaking of the electrical wire in this manner can be had equally as well in a horizontal direction, above a ceiling, just by establishing the entry opening and exit opening for the mouse magnet in appropriate fashion. Orienting the aperture of the mouse magnet 20 at one end of the disk or the other could then allow snaking of the electrical wire either by drawing horizontally to the right or to the left.

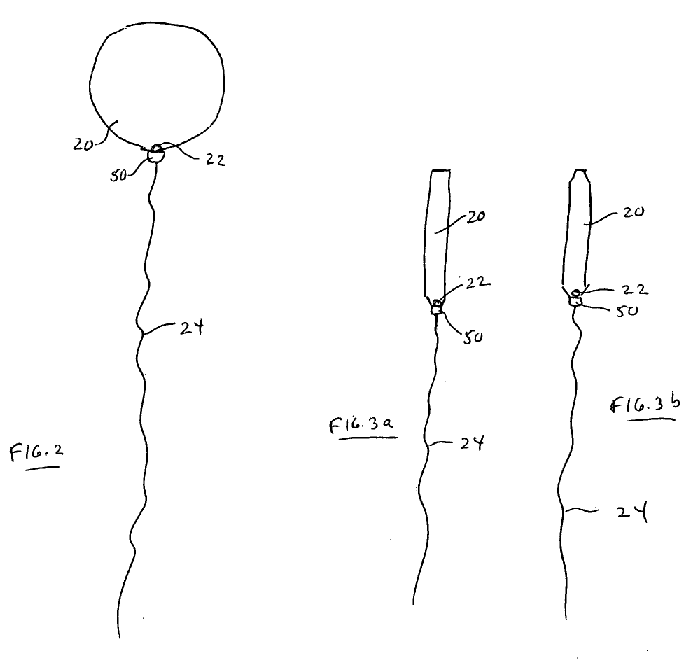

FIG. 2 illustrates a front view of the mouse magnet 20 of the invention as preferably constructed, of substantially circular configuration of ⅞ inch diameter and 1/16 inch thickness. The “hook” coupling to the aperture 22 is shown at 50 with the pull-cord shown at 24. These are also shown in the side view of FIG. 3a, along with a modified form of a mouse magnet in the side view of FIG. 3b to allow further ease in its sliding along the inside surface of the sheetrock wall 10 and in front of the insulation 11 which typically is present. As FIG. 3b indicates, there is a tapering at the ends of the mouse magnet 20 but with the aperture 22 remaining in place as coupled by the hook 50 to the trailing pull-cord 24.

While there have been described what are considered to be preferred embodiments of the present invention, it will be readily appreciated by those skilled in the art that modifications can be made without departing from the scope of the teachings herein. Thus, although FIG. 1 illustrates the mouse magnet 20 as having the aperture 22 at its lower end for snaking the electrical wire 30 upwardly, a like aperture would be required at the top of the mouse magnet if the outlet box hole 14 entry opening and the exit opening 16 were reversed, in snaking an electrical wire downwardly behind the sheetrock wall. Similarly, while the FIG. 1 configuration would be applicable when snaking the electrical wire from right to left in a ceiling construction, the aperture of the mouse magnet would have to be reversed for drawing the electrical wire from left to right in such usage. A more general visualization of the apparatus of the invention for such applications would then necessitate the inclusion of the mouse magnet aperture at the point where placed by the reference numeral 22 as illustrated, as well as one located at the opposite end of the mouse magnet for the alternative movement. For at least such reason, therefore, resort should be had to the claims appended hereto for a true understanding of the invention.

I claim:

1. A method of snaking an electrical wire behind a sheetrock wall or ceiling comprising the steps of:
first, providing a first entry opening and a second exist opening in the sheetrock wall or ceiling;
second, inserting a mouse magnet through said entry opening behind said wall or ceiling, said mouse magnet having an aperture for receiving a trailing pull-cord;
third, coupling one end of said pull-cord to said aperture and a second end of said pull-cord to an electrical wire to be snaked through;
fourth, placing a mother magnet against said sheetrock wall or ceiling on a surface thereof adjacent said entry opening and opposite a point there-behind where said mouse magnet is positioned;
fifth, manually moving said mother magnet along said surface from said entry opening toward said exit opening;
sixth, grasping said mouse magnet when said mouse magnet reaches said exit opening;
seventh, drawing said mouse magnet once grasped through said second opening, along with said trailing pull-cord and electrical wire; and
eighth, uncoupling said one end of said pull-cord from said aperture of said mouse magnet.

2. The method of claim 1 wherein said first step provides a first opening in said sheetrock wall or ceiling via an outlet box opening therein.

3. The method of claim 1 wherein said second step inserts a mouse magnet of substantially circular disk configuration through said entry opening.

4. The method of claim 1 wherein said second step inserts a mouse magnet of circular disk configuration of substantially ⅞ inch diameter and 1/16 inch thickness through said entry opening.

5. The method of claim 1 wherein said third step hooks said one end of said pull-cord to said aperture of said mouse magnet.

6. The method of claim 1 wherein said third step couples said one end of said pull-cord to said aperture at one of an upper and lower end of said mouse magnet.

7. The method of claim 1 wherein said third step couples a nylon cord between said aperture and said electrical wire as said trailing pull-cord.

8. The method of claim 1 wherein said fourth step places a mother magnet having a handle against said sheetrock wall or ceiling, and wherein said fifth step moves said mother magnet by manually moving said handle.

9. The method of claim 1 wherein said fourth step places a mother magnet having a handle movable in at least an upwards and downwards plane against said sheetrock wall or ceiling, and wherein said fifth step moves said mother magnet by manually moving said handle.

10. A method of snaking an electrical wire behind an insulated sheetrock wall or ceiling comprising the steps of:
first, providing a first entry opening and a second exist opening in the sheetrock wall or ceiling;
second, inserting a mouse magnet through said entry opening behind said wall or ceiling in front of the insulation therefor, said mouse magnet having an aperture for receiving a trailing pull-cord;
third, coupling one end of said pull-cord to said aperture and a second end of said pull-cord to an electrical wire to be snaked through;
fourth, placing a mother magnet against said sheetrock wall or ceiling on a surface thereof adjacent said entry opening and opposite a point there-behind where said mouse magnet is positioned;
fifth, manually moving said mother magnet along said surface from said entry opening toward said exit opening;
sixth, grasping said mouse magnet when said mouse magnet reaches said exit opening;
seventh, drawing said mouse magnet once grasped through said second opening, along with said trailing pull-cord and electrical wire; and
eighth, uncoupling said one end of said pull-cord from said aperture of said mouse magnet.

11. The method of claim 10 wherein said first step provides a first opening in said sheetrock wall or ceiling via an outlet box opening therein.

12. The method of claim 10 wherein said second step inserts a mouse magnet of substantially circular disk configuration through said entry opening.

13. The method of claim 10 wherein said third step hooks said one end of said pull-cord to said aperture of said mouse magnet.

14. Apparatus for snaking an electrical wire behind a sheetrock wall or ceiling comprising:
a mouse magnet having an aperture;
a trailing pull-cord having first and second ends;
a mother magnet; and
a length of electrical wire to be snaked;
characterized in that by coupling said pull-cord ends between said mouse magnet aperture and said length of electrical wire respectively, moving said mother magnet along one side of said sheetrock wall or ceiling is effective to move said mouse magnet in a corresponding direction when inserted on an opposite side of said sheetrock wall or ceiling.

15. The apparatus of claim 14 wherein said aperture of said mouse magnet is located at one of an upper and lower end thereof.

16. The apparatus of claim 15 wherein said mouse magnet is of substantially circular disk configuration.

17. The apparatus of claim 15 wherein said mouse magnet is of circular disk configuration of substantially ⅞ inch diameter and 1/16 inch thickness.

18. The apparatus of claim 14 wherein said trailing pull-cord is of nylon composition.

19. The apparatus of claim 14 wherein said mother magnet includes a handle.

20. The apparatus of claim 14 wherein said mother magnet includes a handle movable in at least an upwards and downwards plane.
